(19) United States
(12) Patent Application Publication
(10) Pub. No.: US 2025/0266864 A1
(43) Pub. Date: Aug. 21, 2025

(54) CONFIGURING A RECONFIGURABLE INTELLIGENT SURFACE (RIS)

(71) Applicant: Telefonaktiebolaget LM Ericsson (publ), Stockholm (SE)

(72) Inventors: Guido Carlo FERRANTE, Stockholm (SE); Hugo TULLBERG, Nyköping (SE); Giuseppe CASO, Stockholm (SE)

(73) Assignee: Telefonaktiebolaget LM Ericsson (publ), Stockholm (SE)

(21) Appl. No.: 18/706,168

(22) PCT Filed: Nov. 1, 2021
(86) PCT No.: PCT/SE2021/051090

§ 371 Date: Apr. 30, 2024

(51) Int. Cl. H04B 7/04; H04B 17/309

(52) U.S. Cl. CPC H04B 7/04013; H04B 17/309

(57) ABSTRACT

A method (1100) for configuring a RIS (106), wherein the RIS comprises a plurality of configurable reflectors (120). The method includes obtaining (s1102) a first set of CQM values (e.g., SNR, RSRP, etc.), wherein the first set of COM values is associated with at least a first particular configurable reflector of the RIS, and further wherein each CQM value included in the set is associated with a reflector configuration. The method also includes, based on the obtained first set of CQM values, selecting (s1104) a reflector configuration. The method further includes configuring (s1106) at least the first particular configurable reflector based on the selected reflector configuration. In one embodiments, the method is performed by the RIS and the step of obtaining the CQM values comprises obtaining the CQM values from a network node. In another embodiment, the method is performed by a network node (102, 104, 190) and the step of configuring the first particular configurable reflector comprises transmitting a control message for the RIS, wherein the control message indicates the reflector configuration.

### TECHNICAL FIELD

Disclosed are embodiments related to reconfigurable intelligent surfaces (RISs).

### BACKGROUND

Reconfigurable intelligent surfaces (RISs) are regarded as a promising emerging hardware technology to improve the spectrum and energy efficiency of wireless networks by reconfiguring the propagation environment of electromagnetic waves.

A RIS generally comprises an array of low-cost and low-complexity signal reflectors. The reflectors are passive. That is, a transmitted signal impinging on the RIS is neither amplified nor processed. The reflectors are also configurable (i.e., programmable). That is, the phases of the reflectors can be adjusted in real-time so that an impinging signal can be re-phased by adjusting the phases of the reflectors. This re-phasing is done to efficiently re-direct the impinging signal towards an in-range receiver (e.g., a user equipment (UE)). (See e.g., M. Di Renzo et al., 2020 (reference [1])).

In many cases, the programmability is achieved by equipping the RIS with a network interface and a processing unit (e.g., microcontroller, microprocessor, etc.). The network interface enables the establishment of a control link between the RIS and a network node (e.g., access point, UE, etc.) through which the RIS can receive feedback, for example, in terms of Signal-to-Noise Ratio or Signal-to-Interference-plus-Noise-Ratio (the acronym SNR is used broadly to encompass either ratio) and/or instructions (e.g., how to adjust the phases of reflectors). In some configurations, the processing unit allows the RIS to execute pre-computed instructions (microcontroller), while in other configurations the processing unit computes-and-executes instructions based on the received feedbacks.

RIS deployment aims to increase coverage (e.g., in terms of SNR) at network edge and in poor coverage areas (e.g., indoor environments) and to improve end-user performance (e.g., data rate). RIS deployment is more scalable than massive Multiple-Input-Multiple-Output (MIMO) deployment and heterogeneous network (macro cells and small cells) deployment in terms of complexity, interference management, power consumption, and costs. Use cases include RIS deployment for smart cities (e.g., on the external façade of buildings) and smart indoor environments (e.g., in private homes and large indoor open spaces such as malls and airports).

Theoretical studies assuming complete knowledge of channel coefficients and thus optimal re-phasing of reflectors show a significant potential improvement in terms of SNR in a simple scenario with one user. It has been shown that the maximum achievable SNR gain is equal to the number of reflectors squared. Moreover, as the number of reflectors becomes large, the scaling of the SNR gain does not depend on the re-phasing granularity, and the use of discrete rather than continuous phase shifts only incur a fixed loss independent of the number of reflectors (see, e.g., Q. Wu and R. Zhang, 2020 (reference [2])).

Algorithms to configure a RIS have been proposed. One such algorithm is referred to as “RFocus” (see V. Arun 2019 (reference [3])). RFocus performs the RIS configuration based on SNR feedbacks. Results confirm that SNR gains are attainable using the RFocus algorithm (see reference [3]). The algorithm allows for activating a subset of reflectors to improve the SNR at the receiver end. It performs several iterations to search for the subset of reflectors to activate. It has been shown that power can be focused on a point in space by such a simple on-off strategy.

### SUMMARY

Certain challenges presently exist. For example, there have been few studies with respect to how best configure a RIS and, consequently, there are no specific protocols detailing the procedure that should be followed to configure a RIS. Moreover, most theoretical studies do not delve into a key detail that is necessary for configuring the RIS, namely, how to acquire the knowledge of the channel coefficient phases.

All the RIS configuration algorithms that assume an active channel training phase with cooperation or coordination between the RIS and another end of the communication blur the difference between a RIS and an access point or relay. Some of the existing literature refers to control links that are used to send over full knowledge of channel state information, i.e., the instantaneous channel coefficients to and from the RIS.

Some algorithms attempt to estimate channels using a subset of reflectors with the goal of using the channel estimate on the entire RIS, but these algorithms have limited applicability in practice. This approach is useful only in limited cases, i.e., those cases where the scattering environment is not rich, and the channel is not Rayleigh fading. However, it is in the Rayleigh fading scenario that focusing the wave, rather that only reflecting it, is possible. All existing deep learning algorithms trying to interpolate channel coefficients among different reflectors by only knowing the coefficients for a subset of reflectors cannot theoretically work in the Rayleigh fading scenario because channel coefficients are independent (if reflectors are spaced half-wavelength or more). That makes sense only if reflectors are placed at a distance shorter than half-wavelength, but in that case also the focusing capability and SNR gain are deteriorated.

With respect to the RFocus algorithm mentioned above, this algorithm is limited in at least three respects. First, the algorithm itself is heuristic and is unlikely to achieve the theoretical optimum performance. Second, the algorithm is based on only switching on and off reflectors rather than changing phases. In other words, it works on amplitudes rather than phases. Each reflector either absorbs power or reflect it according to Snell's law. Third, to configure the RIS, a first phase is performed where several random phases and the corresponding SNR feedbacks are collected. During this phase, the performance of the RIS is equivalent to a random algorithm.

Accordingly, there is provided a method for configuring a RIS, wherein the RIS comprises a plurality of configurable reflectors. In one embodiment, the method includes obtaining a first set of channel quality measure (CQM) values (e.g., SNR, RSRP, etc.), wherein the first set of CQM values is associated with at least a first particular configurable reflector of the RIS, and further wherein each CQM value included in the set is associated with a reflector configuration. The method also includes, based on the obtained first set of CQM values, selecting a reflector configuration. The method further includes configuring at least the first particular configurable reflector based on the selected reflector configuration. In one embodiment, the method is performed by the RIS and the step of obtaining the CQM values comprises obtaining the CQM values from a network node. In another embodiment, the method is performed by a network node and the step of configuring the first particular configurable reflector comprises transmitting a control message for the RIS, wherein the control message indicates the reflector configuration.

There is also provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium.

There is also provided a network node that is configured to perform the methods disclosed herein. In some embodiments, the network node comprises a storage unit and processing circuitry coupled to the storage unit, wherein the network node is configured to perform the methods disclosed herein.

An advantage of the embodiments disclosed herein is that they enable configuration of an RIS based on channel quality measurements (CQMs) (e.g., SNR, reference signal received power (RSRP)) feedbacks only. Such kind of feedback provides a small amount of information that an algorithm should receive to be able to configure the RIS, and thus the protocol disclosed herein is based on the simplest possible signaling. Also, the embodiments are shown to work on more general channel models than the Rayleigh fading one presented typically in the literature. Moreover, the embodiments account for the possibility of not only amplitude-only configuration (RIS without the capability of adjusting phases but only turning on and off reflectors) but also configuring phases.

### BRIEF DESCRIPTION OF THE DRAWINGS

The accompanying drawings, which are incorporated herein and form part of the specification, illustrate various embodiments.

FIG. 1 illustrates a communication system according to an embodiment.

FIG. 2 is a flowchart illustrating a process according to some embodiments.

FIG. 3 illustrates a communication system according to an embodiment.

FIG. 4 illustrates a communication system according to an embodiment.

FIG. 5 illustrates a communication system according to an embodiment.

FIG. 6 illustrates a communication system according to an embodiment.

FIG. 7 illustrates a communication system according to an embodiment.

FIG. 8 illustrates a communication system according to an embodiment.

FIGS. 9A-9C illustrate a first set of simulation results.

FIGS. 10A-10C illustrate a second set of simulation results.

FIG. 11 is a flowchart illustrating a process according to some embodiments.

FIG. 12 is a block diagram of a network node according to some embodiments.

FIGS. 13A, 13B, and 13C together illustrate a bisection method for determining an optimal phase shift according to some embodiments.

### DETAILED DESCRIPTION

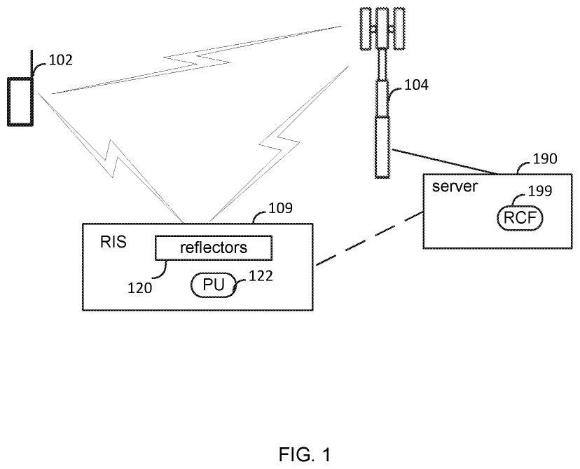

FIG. 1 illustrates a communication system 100 according to an embodiment. Communication system includes: an access point (AP) 104 (e.g., a radio access network (RAN) node a cellular network (e.g., a base station) or other access point), a user equipment (UE) 102, and a RIS 106, which comprises a set of reflectors 120 and a processing unit 122. As used herein a “UE” is any device (e.g., mobile phone, router, sensor, appliance, vehicle) capable of wireless communication with access point 104. As shown in FIG. 1, a signal transmitted by access point 104 impinges on RIS 106 and RIS 106 is configured to reflect the impinging signal toward UE 102. As also shown in FIG. 1, communication system may include a computer 190 (a.k.a., “server”) that executes a RIS control function (RCF) 199 that implements a method for configuring RIS 106. That is, RCF 199 is configured to select the configuration(s) for configuring one or more reflectors of RIS 106.

Presented below is a mathematical model that is a generalization of the ones available in the literature. The model assumes that RIS 106 is equipped with a set of N reflectors, and both UE 102 and AP 104 are equipped with a single antenna.

In the most general scenario, there is a channel between RIS and user (denoted h_{RU}), a channel between access point and RIS (denoted h_{AR}), and a channel between access point and user (denoted h_{AU}). All of them may be in part line of sight, and thus Rician distributed. However, such a general model introduces many parameters, and some of them do not change qualitatively the behavior of the channel. The literature focuses on the absence of h_{AU} and Rayleigh combined channel h_{AR} h_{RU}. To extend the literature, h_{AU} is assumed to be line of sight.

The one in the literature (absent direct path) is the most challenging scenario, where the significant pathloss required for the model to hold demands the use of a RIS; if there was already a line-of-sight (LOS) component due to a wave reflected by a normal (non-intelligent, non-programmable) surface, the higher SNR would not demand the addition of the RIS in the propagation environment.

All channels are quasi-static, which means that they are unknown but fixed. Mathematically, h_{AU} is a complex scalar, and both h_{AR} and h_{RU} are complex Gaussian vectors (Rayleigh fading). From the phase shift point of view, it wouldn't make any difference if either h_{AR} or h_{RU} were line of sight and the other Rayleigh (although it would make a small quantitative difference with respect to the amplitude distribution, which we may regard as a detail since also Rayleigh fading is an approximation of reality).

To make notation simpler, let h_{d}=h_{AU}, h₁=h_{AR}, and h₂=h_{RU}. If a complex symbol x is transmitted on a resource element, then the received signal y is thus given by:

$$y = [ \sqrt{κ} {h}_{d} + \sqrt{1 - κ} {\sum }_{i = 1}^{n} {h}_{1 i} {h}_{2 i} {a}_{i} {e}^{i {φ}_{i}} ] x + z$$

where the parameter κ∈[0, 1] determines the relative power coming from the line-of-sight (LOS) path. Here, the amplitudes (aᵢ)ᵢ₌₁ⁿ and phases (φᵢ)ᵢ₌₁ⁿ are chosen by the RIS. Notice that all other channels are complex, and thus the phases (φᵢ)ᵢ₌₁ⁿ are added to the phases of channel branches (h₁ᵢh₂ᵢ)ᵢ₌₁ⁿ. In the expression above, the variance of x accounts for the received power (=transmitted power−pathloss) and the variance of the noise z and all channel coefficients can be set to unity.

The maximum SNR (divided by the variance of x) in the absence of direct path (κ=0) is n², or 20 log₁₀ n in dB. As mentioned above, a few algorithms to configure a RIS have been proposed in the literature in an attempt to reach such gain. The literature is mostly focused on the scenario with no direct path.

### Brief Summary of Various Embodiments

Described herein are different architectures to enable coordination among UE 102, AP 104, RIS 106, and RCF 199 to configure the RIS. Also described are methods performed by RCF 199 for selecting a RIS configuration. The selection, in one embodiment, is based solely on channel quality measurements (CQMs) (e.g., SNR measurements). FIG. 1 shows RCF 199 being executed server 190 (e.g., a server in the “cloud”), but in other embodiments, RCF 199 can be executed by another network node, such as AP 104, UE 102, or the RIS 106 itself. In one embodiment, RIS 106 is configured to advertise its features and capabilities.

Several different architectures are proposed. The architectures differentiate in terms of the network node that executes RCF 199. In this respect, cloud-based, AP-based, RIS-based, and UE-based architectures are proposed. The architectures also differentiate in terms of the network node that establishes the control link towards RIS 106.

Several methods performed by RCF 199 to configure RIS 106 are proposed. Two classes of methods are described, which are referred to as “sequential’ and “simultaneous.” Methods in the sequential class work by adjusting the reflectors of RIS 106 one at a time. Methods in the simultaneous class work by jointly adjusting all reflectors of RIS 106.

### Details of Various Embodiments

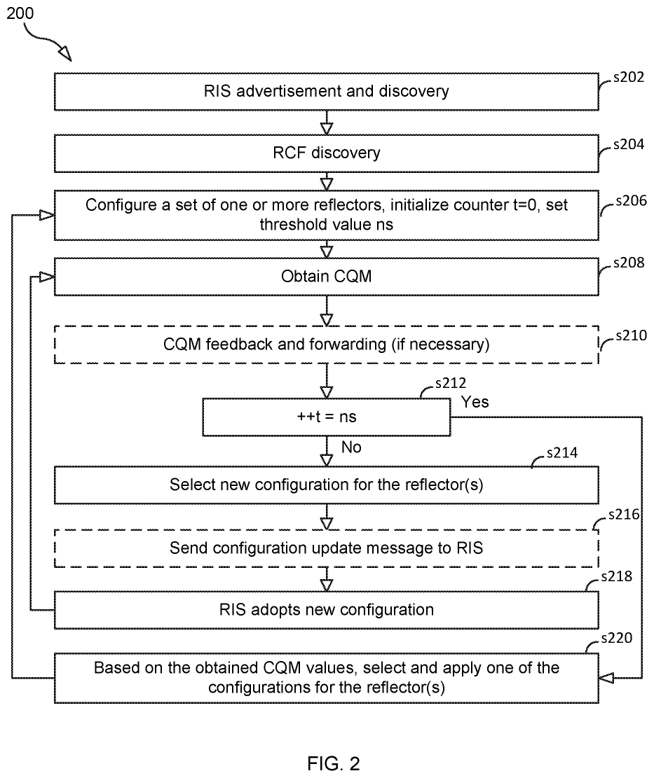

Described below are ways to configure RIS 106 so as to improve performance (e.g., increase the SNR) of the combined direct (AP-UE) and reflected (AP-RIS-UE) channels. FIG. 2 is a flowchart illustrating a process 200, according to one embodiment, to execute the configuration of RIS 106. The steps of process 200 are described below.

S202. RIS advertisement and discovery: RIS 106 transmits periodically a beacon signal (e.g., over the low-power IoT communication link) to advertise itself and its capabilities; and AP 104 or UE 102 receive the beacon, thereby discovering the RIS. The beacon may include information indicating capabilities of RIS 160

S204. RCF discovery: The network node that receives the beacon initiates a signaling exchange to determine where RCF 199 is executed—in the network (AP 104 or server 190), in UE 102, or in RIS 106.

S206. In this step RCF 199 selects a set of one or more reflectors and selects a configuration for the reflector(s). And in this step a counter variable (t) may be set equal to 0 and a quantization variable (nₛ) for the reflector(s) is set (e.g., nₛ=8). If RIS 106 does not execute RCF 199, then RCF 199 communicates the selected configuration so that it can be received and implemented by RIS 106.

S208: Obtain CQM: UE 102 obtains a CQM (e.g., UE 102 measures the SNR).

S210. COM feedback and forwarding (if necessary): If RCF 199 is executed in UE 102, proceed to step s212, otherwise UE 102 transmits CQM to AP 104 or to RIS 106. If RCF 199 is executed in server 190, UE transmits CQM to AP 104 which then forwards the CQM to server 190.

S212. In this step, t is incremented by one and the new t value is compared to nₛ. If the new t value is equal to nₛ, then process 200 skips to step s220, otherwise, process 200 proceeds to step s214.

S214. In this step RCF 199 uses one of the below described methods to select a configuration for the set of reflectors. For example, RFC 199 may randomly select a configuration (e.g., phase shift) or RFC 199 may select a configuration from a list of configurations or RFC may use a bisection method to select a configuration.

S216. Send configuration update message to RIS 106 (if necessary): If RCF 199 is not executed by RIS 106, the configuration (e.g., phase shift information) is feed back to RIS 106. Otherwise, proceed to step s218.

S218. RIS 106 adopts the new configuration. After step s218 is performed, process 200 returns to step s208.

S220. In this step, RCF 199 uses all of the CQM values that have been obtained to select a configuration for the reflectors and applies the reflected configuration. That is, for example, each CQM value is associated with a configuration, and RCF 199 determines the best CQM value (e.g., the highest CQM value or the lowest CQM value) and then selects the configuration with which the best CQM value is associated. This selected configuration is then applied by RIS 106 (the selected configuration needs to be communicated to RIS 106 if RIS 106 does not execute RCF 199).

After step s220 is performed the process may back to step s206 where RCF 199 selects a new set of one or more reflectors, or the process may end (e.g., the process may end once all reflectors of RIS 106 have been configured).

Using process 200, at least a subset of the reflectors of RIS 106 can be configured so as to improve the performance of communication system 100 (i.e., improve the combined direct (AP-UE) and reflected (AP-RIS-UE) channels).

### Details on the Signaling Phase for Architecture Selection

In one embodiment, a lightweight discovery-and-configuration procedure is implemented so that the involved system entities can preliminarily coordinate and select one of the architectures described above. The procedure is carried out on the control link, assuming that this link is always active between RIS 106 and at least one of the other network nodes (AP 104 and/or UE 102). The following operations and signaling are performed:

1. RIS advertisement: RIS 106 advertises its presence along with its features and capabilities via beacon packets on the control link, e.g., an Internet-of-Things (IoT) broadcast link. In particular, RIS 106 informs if it is ready to be used, how many reflectors it has, and if its processing unit is equipped with a microprocessor along with a microcontroller so that Architectures 2a and 2b (described below) may be considered as available options.

2. RIS discovery: Either AP 104 or UE 102 receives the beacon, decodes it, and initiates the RCF selection phase.

3. RCF selection: Once RIS 106 is discovered, access point and UE 102 coordinate by adopting an ACK/NACK message exchange on the architecture to be used (e.g., the device has to communicate if it is able to compute the phase shifts so that Architectures 3a and 3b may be considered as available options, while AP 104 can communicate its preferences on the architectures to be used). This can be done on the control link but also on the main data/signaling link if one entity (e.g., UE 102) is not equipped with the control link. Finally, RIS 106 is informed on the agreed architecture via a control link.

### Details on the Control Link

In all the proposed architectures, a control link is needed for communicating with RIS 106. It can be observed that such a link is needed for sending a small number of bits to RIS 106 so to transmit either SNR feedbacks (up to tens of kbps) or configuration information (e.g., phase shifts) (up to hundreds of kbps). While also considering the need for maintaining satisfactory energy efficiency at RIS 106 end, a Low-Power Wide-Area Network (LPWAN) technology could be directly employed for the control link establishment. Among others, cellular-based IoT (CIoT) technologies, such as Narrowband IoT (NB-IoT), can be envisioned for this task.

### Details on the Architectures

Six different architectures for augmenting a communication link with a RIS are described below.

### Architecture 1a: Network-Based RIS Configuration and Network-Based RIS Control

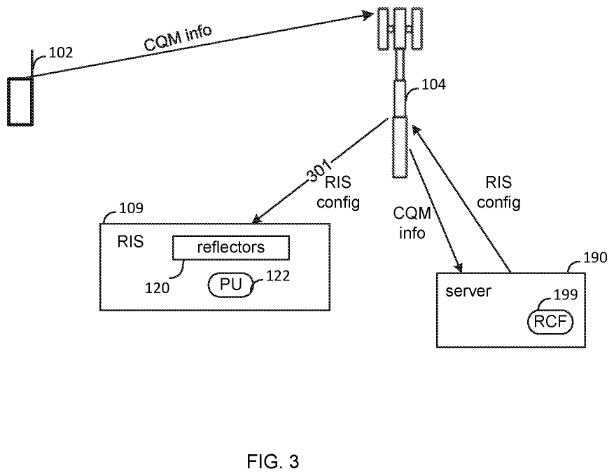

Architecture 1a is illustrated in FIG. 3. In this architecture, RCF 199 is executed by server 190, which may be a cloud server or edge-cloud server. In addition, a control link 301 is established between AP 104 and RIS 106 so that AP 104 can forward the selected RIS configuration (e.g., computed phase shifts) to RIS 106. Finally, processing unit 122 RIS 106 is equipped with a microcontroller for executing the received configuration. The following operations and signaling are performed:

1. COM (e.g., SNR) feedback: For each data signal transmitted by AP 104 to UE 102, UE 102 receives the data signal, evaluates a CQM (e.g., SNR), and then sends to AP 104 CQM feedback information specifying the evaluated CQM.

2. CQM forwarding: AP 104 forwards the CQM feedback information server 190.

3. RCF execution: Server 190 executes RCF 199, which is configured to select an RIS configuration to be applied by RIS 106 reflectors during the next packet transmission.

4. Configuration update message: AP 104 receives the new RIS configuration (e.g., phase shifts) from server 190 and in turn communicates it to RIS 106 via the control link 301.

5. Configuration update: Upon receiving the RIS configuration from AP 104, RIS 106 configures at least one reflector to apply the new configuration via the processing unit 122.

### Architecture 1b: Network-Based RIS Configuration and User-Based RIS Control

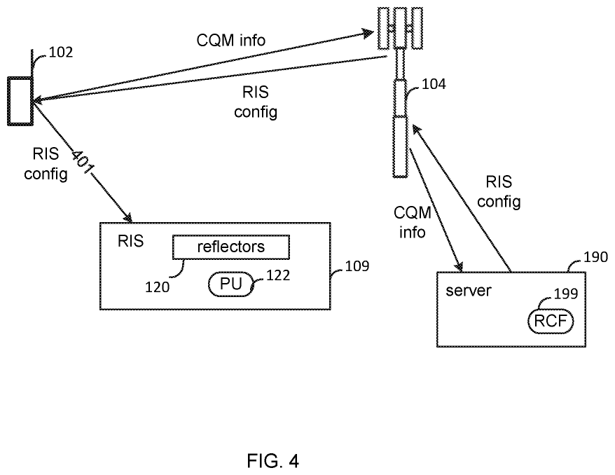

Like Architecture 1a, Architecture 1b, which is illustrated in FIG. 4, also exploits server 190 for evaluating the configuration of RIS 106 reflectors. However, in this embodiment, a control link 401 is established between UE 102 and RIS 106 so that the former can forward the RIS configuration to the latter, after receiving them from AP 104. The following operations and signaling are performed:

1. COM feedback: As Architecture 1a.

2. CQM forwarding: As Architecture 1a.

3. Algorithm execution: As Architecture 1a.

4. Configuration update message: AP 104 receives the new RIS configuration from server 190 and in turn communicates them to UE 102 adopting the same feedback-based communication protocol used for CQM feedback. Then, UE 102 communicates the RIS configuration to RIS 106 via the control link 401.

5. Configuration update: As Architecture 1a.

### Architecture 2a: RIS-Based RIS Configuration and Network-Based RIS Control

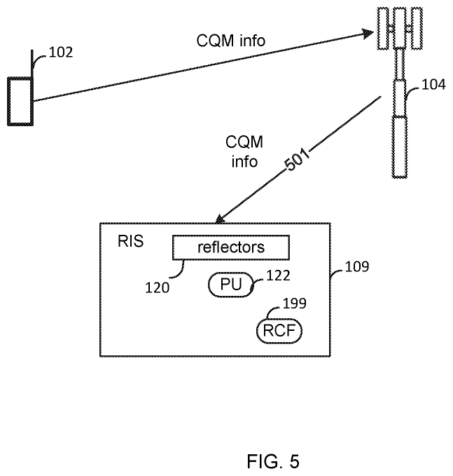

In Architecture 2a, which is illustrated in FIG. 5, processing unit 122 of RIS comprises a microcontroller and a microprocessor for executing RFC 199 (e.g., evaluating the configuration of RIS 106 reflectors). In addition, a control link 501 is established between AP 104 and RIS 106 so that the former can forward the CQM feedbacks to the latter, after receiving them from UE 102. Finally, the on-RIS microcontroller executes the configuration evaluated by the microprocessor. The following operations and signaling are performed:

1. CQM feedback: As Architecture 1a.

2. CQM forwarding: AP 104 forwards CQM feedbacks to RIS 106 via the control link 501.

3. RCF execution: The on-RIS microprocessor executes RCF 199 which performs a method for selecting the RIS configuration (e.g., evaluating the phase shifts to be applied by RIS 106 reflectors) during the next packet transmission.

4. Configuration update message: The microprocessor forwards the computed RIS configuration to the microcontroller.

5. Configuration update: The microcontroller instructs the reflectors to apply the new RIS configuration.

### Architecture 2b: RIS-Based RIS Configuration and User-Based RIS Control

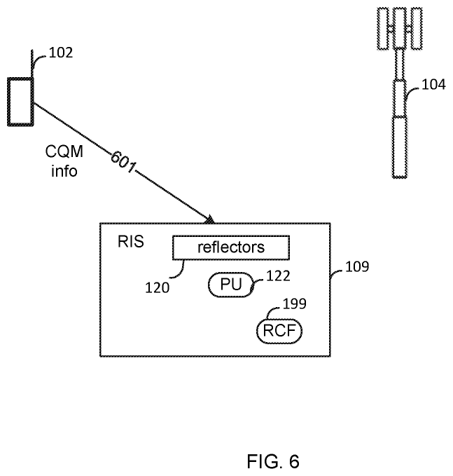

Like Architecture 2a, Architecture 2b, which is shown in FIG. 6, exploits an on-RIS microprocessor for evaluating the configuration of RIS 106 reflectors. However, a control link 601 is this case established between UE 102 and RIS 106 so that the former can forward the CQM feedbacks to the latter. The following operations and signaling are performed:

1. CQM feedback: UE 102 evaluates the CQM on each data packet received by the network access point and sends it to RIS 106 via the control link.

2. Algorithm execution: As Architecture 2a.

3. Configuration update message: As Architecture 2a.

4. Configuration update: As Architecture 2a.

### Architecture 3a: User-Based RIS Configuration and Network-Based RIS Control

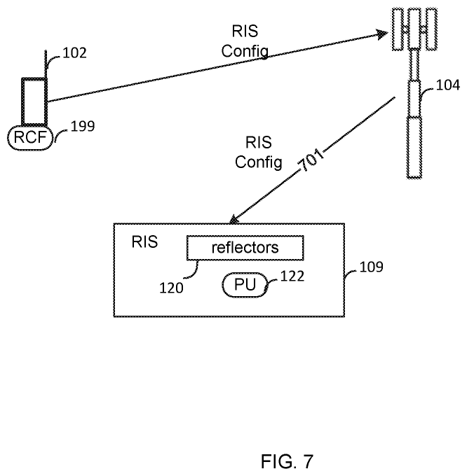

In Architecture 3a, which is illustrated in FIG. 7, RCF 199 is executed by UE 102. In addition, a control link 701 is established between AP 104 and RIS 106 so that the former can forward the RIS configuration to the latter, after receiving them from UE 102. Finally, RIS 106 is equipped with a microcontroller for executing the received RIS configuration. Note that, compared to the previous architectures, in this and following case, there is no need for CQM feedback and/or forwarding steps, since UE 102 computes the CQM values and uses them for the local execution of the configuration algorithm. Therefore, the following operations and signaling are performed:

1. COM and Algorithm execution: UE 102 evaluates the CQM on each data signal received from AP 104 and uses them for executing one of the proposed methods for evaluating the configuration (e.g., phase shifts) to be applied by RIS 106 reflectors during the next packet transmission.

2. Configuration update message: UE 102 communicates the configuration to AP 104 adopting a feedback-based communication protocol. Then, AP 104 communicates the RIS configuration to RIS 106 via the control link 701.

3. Configuration update: As Architecture 1a.

### Architecture 3b: User-Based RIS Configuration and User-Based RIS Control

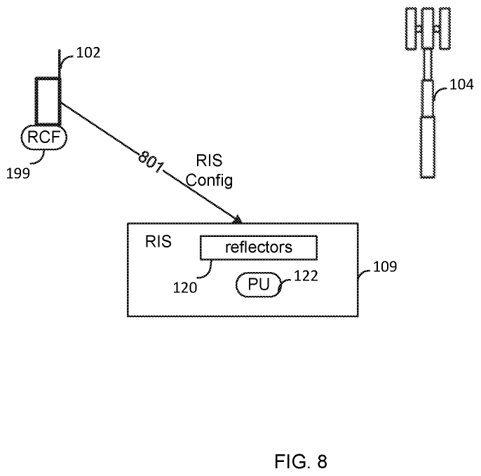

Like in architecture 3a, in Architecture 3b, which is shown in FIG. 8, UE 102 executes RCF 199 for evaluating the configuration of RIS 106 reflectors. However, a control link 801 is this case established between UE 102 and RIS 106 so that the former can forward the configuration information to the latter. The following operations and signaling are performed:

1. COM and Algorithm execution: As Architecture 3a.

2. Configuration update message: UE 102 communicates the configuration information to RIS 106 via the control link 801.

3. Configuration update: As Architecture 1a.

### Architectural Trade-Offs

The proposed architectures differently leverage the existing tradeoff between communication, computational capabilities, and energy consumption across the involved system entities, and particularly at RIS 106.

On the one hand, Architectures 1a, 1b, 3a, and 3b require RIS 106 to be equipped with a microcontroller, thus minimizing RIS computational power and energy consumption. However, these architectures require increased communication capabilities due to the need for transmitting the selected configuration information towards RIS 106 in a timely manner. Architecture 3b results in the lowest communication requirement compared to Architectures 1a, 1b, and 3a, since the entity executing RCF 199 (i.e., UE 102) does not need to feedback CQM values towards to the network (as in Architectures 1a and 1b) and is also part of the control link towards RIS 106, thus making it possible to transmit the configuration information directly to RIS 106 (differently from Architecture 3a, where the configuration first transmitted to AP 104 and then to RIS 106). Architecture 3b, however, leads to increased energy consumption at UE 102 due to the local execution of the configuration algorithm (RCF 199).

On the other hand, in Architectures 2a and 2b, RIS 106 locally executes the configuration algorithm through a microprocessor. This maximizes RIS computational power and energy consumption while minimizing the need for communication, since CQM feedbacks are transmitted to RIS 106 via the control link but the configuration information is readily available to the microcontroller after being computed by the on-RIS microprocessor. Architecture 2b results in a single-hop CQM feedback (from UE 102 to RIS), but the need for establishing the control link also incurs in addition power consumption at the user end compared to Architecture 2a.

In all the proposed architectures, the selection of the configuration is executed by via one of the proposed methods, described in the following.

Details on Methods performed by RCS 199 for selecting a reflector configuration (e.g., phase shift):

The methods are categorized in terms of their action on reflectors. They act on reflectors in a sequential or simultaneous manner, and by adjusting their phases or amplitudes.

Referring to RFocus, RFocus is a simultaneous on-off algorithm. It acts at the same time on all reflectors and tries to select the best subset of reflectors to be on. When a reflector is on, it reflects the impinging wave. If it is turned off, then it absorbs the impinging wave. Intuitively, there should be a subset of reflectors turned off if their phases cannot be changed, as is the case of RFocus, since the reflected wave can interfere destructively at the receiver. The exact procedure followed by RFocus is explained in reference [3]. At a high level, the algorithm performs a certain number of iterations during each of which some reflectors are turned on or off, and the new configuration is kept according to a majority rule.

In sequential algorithms, there is an implicit order of reflectors that needs to be chosen beforehand. Given the channel model that we are using such an order is irrelevant, namely reflectors can be chosen at random. However, in practice, there may be cases where a particular order is preferable to the random one.

Simultaneous vs sequential algorithms differ as follows:

Simultaneous: at each iteration of the algorithm, all reflectors are adjusted at the same time.

Sequential: At the beginning of the configuration phase, only one reflector is activated, and all others absorb the impinging wave. After the configuration of the reflector is completed, a second reflector is configured while the phase of the first one remains fixed, and so on. Thus, during the configuration of reflector m, there are m−1 reflectors that are active and whose phases are kept fixed, and n-m reflectors that are inactive and absorb the impinging wave.

### Method 1: Simultaneous Random Baseline (Random Phases)

In the Simultaneous Random Baseline method, all reflectors are always on. For a predetermined number of iterations, phases of all reflectors are randomly and independently chosen. A feedback is received at each iteration, and the configuration with the best feedback is kept track of.

### Method 2: Sequential Random Phases

In the Sequential Random Phases method, during the configuration of a reflector, a number of random phases are tried (equal to the number of iterations that can be spent to configure one reflector, that is the total number of iterations allowed for configuration divided by the number of reflectors). The best phase is then kept.

### Method 3: Sequential List Phase Discovery

In the Sequential List Phase Discovery method, during the configuration of a reflector, a list of phases is attempted. The list is predetermined and arbitrary. To be concrete, consider a regular phase discovery where a length-m list is given by {0, 2π/m, 2*2π/m, . . . , (m−1)*2π/m}. An early-stop strategy can be implemented as follows. As soon as the second difference, i.e., the discrete version of the second derivative of the SNR feedback is negative, which requires m≥3, the algorithm is stopped, and the next reflector, if any remain, is configured.

### Method 4: Sequential Bisection Phase Discovery

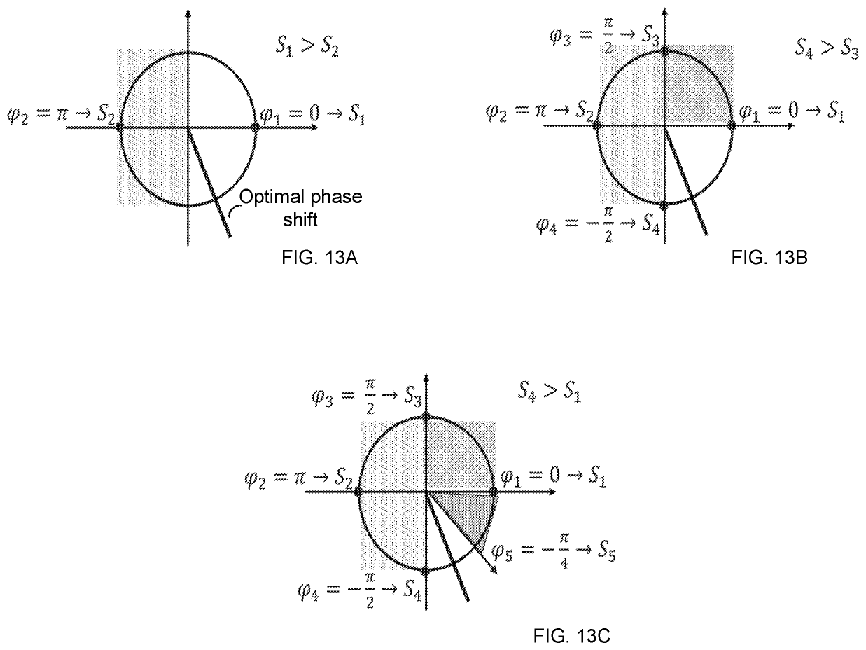

In the Sequential Bisection Phase Discovery method, the method proceeds sequentially as in the previous method, but now there is no predetermined list. Instead, a prefixed number of iterations is performed on the configuration of each reflector to determine (e.g., estimate) the optimal phase shift for the reflector. The method identifies a phase interval in which the optimal phase shift for the reflector can be found, and the reflector is re-phased by considering the mid-point of such an interval. To identify the interval, a “bisection” method is applied. The bisection method according to one embodiment is illustrated in FIGS. 13A, 13B, and 13C and includes the following steps.

Step 1: The phase shift for the reflector under consideration is set to 0 (i.e., φ₁=0) and then an SNR feedback value S₁ is received (see FIG. 13A).

Step 2: The phase shift for the reflector is set to π (i.e., φ₂=π). The SNR feedback value received is S₂ (see FIG. 13A). Based on S₁ and S₂, we reject a half plane. Because in this example, S₁>S₂, the left-half plane is rejected (i.e., the angles outside [−π/2, π/2). Had S₁ not been greater than S₂, then the right half-plane (i.e., angles in [−π/2, π/2]) would have been rejected.

Step 3: The phase shift for the reflector is set to π/2 (i.e., φ₃=π/2) and then the feedback SNR values received is S₃ (see FIG. 13B).

Step 4: The phase shift for the reflector is set to −π/2 (i.e., φ₄=−π/2) and then the SNR feedback value received is S₄. Based on S₃ and S₄, we reject a quarter plane. If S₄>S₃, we reject the upper quarter-plane, i.e., angles in [0, π/2]. Otherwise, we reject the lower quarter-plane, i.e., angles in [−π/2, 0]. In FIG. 13B, the upper quarter-plane is rejected because S₄>S₃.

From this step on, the algorithm proceeds iteratively. The algorithm has already discovered a quarter plane where the correct angle lies. Therefore, we specify the below step as “step k” where k=5, 6, . . . up to a predetermined limit.

Step k: Define the best extreme angle as the angle between the two current extreme angles at which feedback is maximum. For example, in FIG. 13B, the two extreme angles are φ₄=−π/2 and φ₁=0, therefore the best extreme angle is φ₄=−π/2 because S₄>S₁. Compute the angle that lies in the middle of the two extreme angles referred to as the mid-angle. For example, in FIG. 13C the mid-angle is φ₅=−π/4. Accept the part of plane between the mid-angle and the best extreme angle. The two extreme angles become, therefore, the mid-angle and the best extreme angle. In FIG. 13C, we accept the part of plane between φ₅ and φ₄ because S₄>S₁. In another example, it could have happened that S₄<S₁, in which case we would have accepted the part of plane between φ₅ and φ₁. Finally, unless step k is the last step, receive feedback Sₖ, which will be used at the next step. If this is the last step, consider the mid-angle between the two new extreme angles, and report that angle as the output of the method. Any other angle in the interval would perform similarly. For example, if k=5 was the last step, the output of the method would be φ₆=−3π/8. Any other angle between φ₄ and φ₅ would perform similarly.

### Method 5: Sequential On-Off Discovery

In the Sequential On-Off Discovery method, the method proceeds sequentially as in the previous algorithm but now there is no re-phasing. Reflectors can only be activated, in which case they reflect the impinging wave, or deactivated, in which case they absorb the impinging wave. For each reflector, both configurations are tested, and the best one is kept.

Variations of the above embodiments:

In one embodiment, a subset of reflectors is configured with higher quantization than the remaining (e.g., for a subset of reflectors nₛ=8, whereas for the remaining reflectors nₛ=4). In another embodiment, each reflector is independently assigned a quantization value.

In another embodiment, a multi-stage algorithm is applied where at each stage the increment in the feedback metric before and after configuration is taken track of, and each stage focuses more resources (e.g., iterations) towards those reflectors that already showed the largest (or the lowest) increment in previous stages, thereby increasing inequality (or equality) of the configuration accuracy across reflectors.

In another embodiment, subsets of reflectors are configured (per iteration or step of the algorithm) instead of one at a time, up to the extreme case where all reflectors are configured simultaneously, possibly repeatedly.

There are simultaneous counterparts to some of the above sequential algorithms that are not describe here for brevity. They can be considered variations of the sequential algorithms.

### Performance Evaluation

The maximum SNR (divided by the variance of x) in the presence of a direct path is given by:

$${S}_{max} = κ + ( 1 - κ ) ( n + n ( n - 1 ) π / 4 ) + 2 \sqrt{κ ( 1 - κ )} n π / 4.$$

The terms including π/4 are due to Rayleigh fading; if the amplitudes were exactly unit-norm rather than Rayleigh distributed with unit second moment, those π/4 would be equal to 1, and the expression would simplify slightly. The important fact is that when κ≠1 the scaling of Sₘₐₓ is with n², as reported in the literature.

If RIS 106 is not configured, then S_{nc}=κ+(1−κ)n. In this case, the scaling of SNR is with n rather than n².

In some of the literature, the SNR gain is also reported to scale with n² but we should clarify what such a gain is referring to. The SNR gain reported in the literature refers to the difference in SNR (dB) between the case of configured RIS and the absence of RIS or equivalently a RIS with one element only. Notice that the number of channel branches differs in the two cases.

Therefore, we call SNR gain the gain in SNR that we get by configuring RIS 106. That is, the difference in SNR (dB) between the configured and un-configured RIS.

$$G ( κ ) := \frac{{S}_{max}}{{S}_{nc}}$$

$$or in dB$$

$$10 {log}_{10} G ( κ ) := 10 {log}_{10} {S}_{max} - 10 {log}_{10} {S}_{nc} .$$

Therefore, G˜n for n large (for κ≠1) because Sₘₐₓ˜n² but S_{nc}˜n.

### Simulation Results

We present below simulation results showing the gain G in SNR achieved with the different algorithms detailed above. In the present setting, the SNR gain translates into a throughput gain via the expression R=log₂(1+SNR).

Simulation results were obtained. The simulations began with the case of no direct path with relatively few reflectors and relatively short configuration time measured in terms of number of feedbacks received. Then we investigated the case with 4× more reflectors and proportional larger configuration time. Finally, we repeated the last investigation in the presence of a direct path.

In all cases, our proposed sequential bisection algorithm approaches the theoretical maximum. RFocus was shown to perform worse. Among the proposed algorithms, the sequential on-off algorithm is shown to perform similarly to RFocus but without the long left-tail of the latter. Moreover, the benefit of sequential algorithms is that the evolution of the gain is monotonic while RFocus is designed to collect the feedbacks of random choices and process them, but in so doing the evolution of the gain is equal to the simultaneous random algorithm up to the very last step, at which RFocus processes the data differently than just picking the best outcome.

From the simulation results, we concluded that: gain G increases as number of reflectors increases and RIS 106 is well-configured; the sequential bisection method approaches the theoretical maximum gain; the sequential on-off algorithm performs similarly to RFocus but without the left-tail gains (losses); in the presence of a direct path that does not bring the majority of the power received by the user, a configured RIS still offers a significant SNR gain; we do not report the case where the direct path brings the vast majority of the power since in that case the maximum theoretical gain is very limited and not representative of the expected use case of a RIS deployment; the quantization of re-phasing is not a major limiting factor for achieving nearly-optimal gains; and configuring well (high accuracy, high quantization) a subset of reflectors rather than configuring at best all reflectors is beneficial (thereby opening the possibility of an algorithm where a subset of reflectors is well-configured while the remaining is coarsely configured).

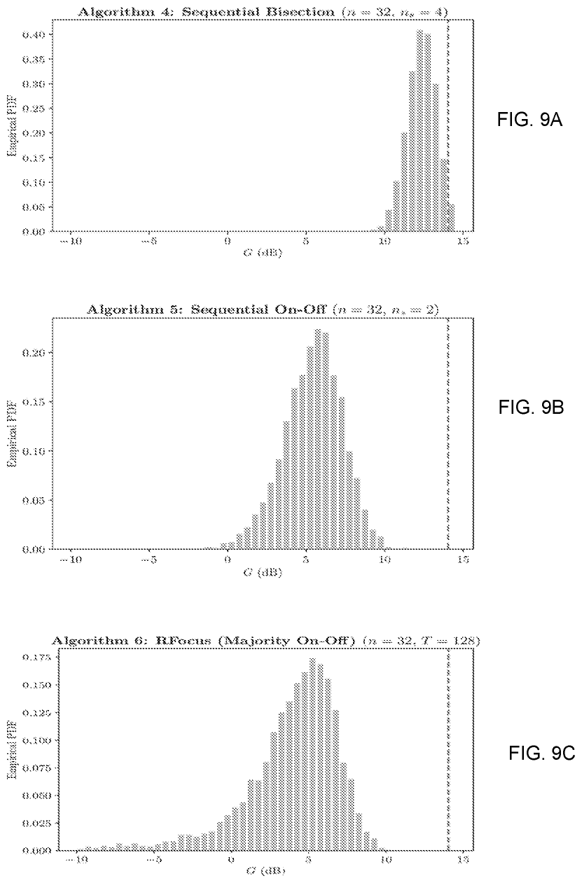

FIGS. 9A-9C show simulation results for the Sequential Bisection Phase Discovery, Sequential On-Off Discovery, and RFocus methods, respectively where the RIS has 32 reflectors and the quantization (nₛ) is 4 for Sequential Bisection Phase Discovery (i.e., the total number of simulated configurations per reflector) and nₛ is 2 for Sequential On-Off Discovery. For RFocus, the total number of iterations (T) is equal to 128. Each of FIGS. 9A-9C shows the distribution of gains at the end of configuration for the given method. Randomness is due to different channel realizations. The vertical dashed line corresponds to the maximum theoretical gain averaged over channel realizations.

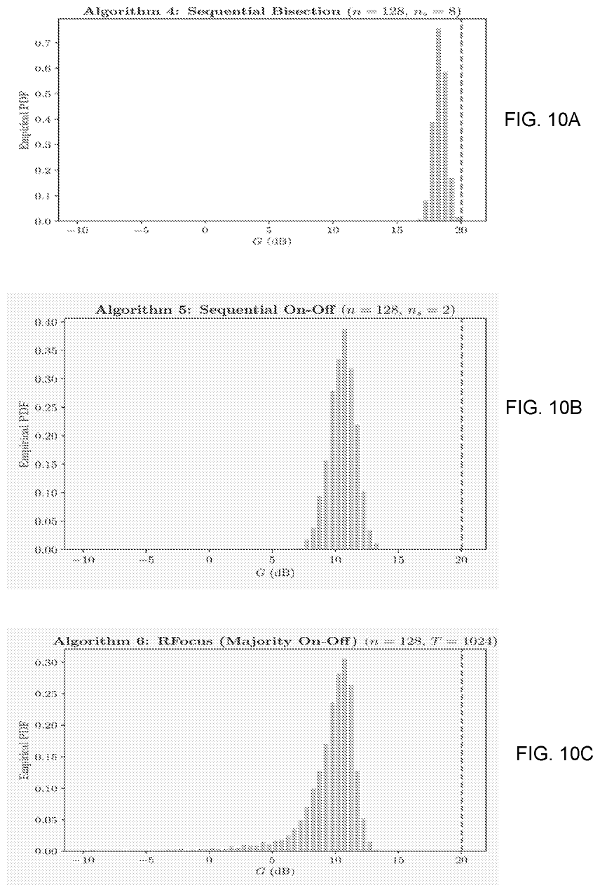

FIGS. 10A-10C show simulation results for the Sequential Bisection Phase Discovery, Sequential On-Off Discovery, and RFocus methods, respectively where the RIS has 1024 reflectors and the quantization was 8 for Sequential Bisection Phase Discovery and 2 for Sequential On-Off Discovery. Each of FIGS. 10A-10C shows the distribution of gains at the end of configuration for the given method. Randomness is due to different channel realizations. The vertical dashed line corresponds to the maximum theoretical gain averaged over channel realizations.

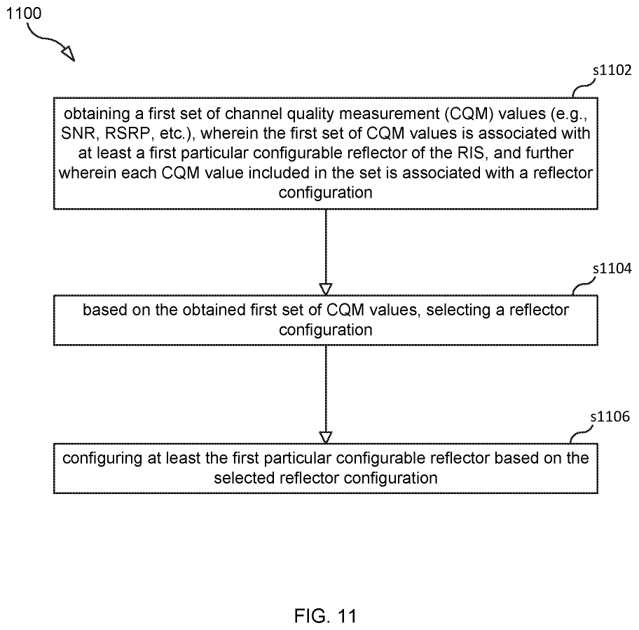

FIG. 11 is a flowchart illustrating a process 1100, according to an embodiment, that is performed by a network node (server 190, AP 104, UE 102, RIS 106) for configuring RIS 106. Process 1100 may begin in step s1102.

Step s1102 comprises obtaining a first set of channel quality measurement (CQM) values (e.g., SNR, RSRP, etc.), wherein the first set of CQM values is associated with at least a first particular configurable reflector of the RIS, and further wherein each CQM value included in the set is associated with a reflector configuration.

Step s1104 comprises, based on the obtained first set of CQM values, selecting a reflector configuration.

Step s1106 comprises configuring at least the first particular configurable reflector based on the selected reflector configuration. In one embodiment, the method is performed by the RIS and the step of obtaining the CQM values comprises obtaining the CQM values from a network node. In another embodiment, the method is performed by a network node (e.g. UE 102, AP 104, server 190) and the step of configuring the first particular configurable reflector comprises transmitting a control message for the RIS, wherein the control message indicates the reflector configuration. The control message for the RIS may be transmitted directly to the RIS or indirectly to the RIS (e.g., AP 104 may transmit the control message to UE 102 which then relays the control message to RIS 106).

In some embodiments, obtaining the first set of CQM values comprises: configuring the first particular configurable reflector in accordance with a first reflector configuration; after configuring the first particular configurable reflector in accordance with the first reflector configuration, obtaining a first CQM value (CQM1) associated with the first reflector configuration; configuring the first particular configurable reflector in accordance with a second reflector configuration; and after configuring the first particular configurable reflector in accordance with the second reflector configuration, obtaining a second CQM value (CQM2) associated with the second reflector configuration.

In some embodiments, selecting a reflector configuration based on the obtained first set of CQM values comprises: determining the best CQM value from among the CQM values included in the first set of CQM values; and selecting the reflector configuration associated with the best CQM value. In some embodiments, selecting a reflector configuration based on the obtained first set of CQM values comprises: comparing the first CQM value with the second CQM value; and selecting the first or second reflector configuration based on the comparison. In some embodiments, selecting the first or second reflector configuration based on the comparison comprises: selecting the first reflector configuration if the first CQM value is greater than the second CQM value; selecting the second reflector configuration if the first CQM value is less than the second CQM value; or selecting either the first or the second reflector configuration if the first CQM value is equal to the second CQM value.

In some embodiments, the first reflector configuration specifies a first phase shift, configuring the first particular configurable reflector in accordance with the first reflector configuration comprises configuring the first particular configurable reflector to produce the first phase shift, the second reflector configuration specifies a second phase shift, and configuring the first particular configurable reflector in accordance with the second reflector configuration comprises configuring the first particular configurable reflector to produce the second phase shift.

In some embodiments, the first phase shift is X radians, and the second phase shift is (X+π) or (X−π) radians.

In some embodiments, obtaining the first set of CQM values further comprises: configuring the first particular configurable reflector in accordance with a third reflector configuration; after configuring the first particular configurable reflector in accordance with the third reflector configuration, obtaining a third CQM value (CQM3) associated with the third reflector configuration; configuring the first particular configurable reflector in accordance with a fourth reflector configuration; and after configuring the first particular configurable reflector in accordance with the fourth reflector configuration, obtaining a fourth CQM value (CQM4) associated with the fourth reflector configuration, wherein the third reflector configuration specifies a third phase shift, configuring the first particular configurable reflector in accordance with the third reflector configuration comprises configuring the first particular configurable reflector to produce the third phase shift, the fourth reflector configuration specifies a fourth phase shift, and configuring the first particular configurable reflector in accordance with the fourth reflector configuration comprises configuring the first particular configurable reflector to produce the fourth phase shift, the third phase shift, φ3, is (X+π/2) or (X−π/2) radians, and the fourth phase shift, φ4, is (φ3+π) or (φ3−π).

In some embodiments, obtaining the first set of CQM values further comprises: selecting a fifth phase shift, φ5, based on the obtained CQM values, wherein φ5=(φ1−π/4) if (CQM1>CQM2 && CQM4>CQM 3), φ5=(φ1+π/4) if (CQM1>CQM2 && CQM3>CQM 4), φ5=(φ2+π/4) if (CQM2>CQM1 && CQM4>CQM 3), or φ5=(φ2−π/4) if (CQM2>CQM1 && CQM3>CQM 4); and configuring the first particular configurable reflector to produce the fifth phase shift, and after configuring the first particular configurable reflector to produce the fifth phase shift, obtaining a fifth CQM value, CQM5, associated with the fifth phase shift.

In some embodiments, obtaining the first set of CQM values further comprises selecting a sixth phase shift, φ6, based on the obtained CQM values, wherein φ6=(φ5−π/8), or φ6=(φ5+π/8)); configuring the first particular configurable reflector to produce the sixth phase shift, and, after configuring the first particular configurable reflector to produce the sixth phase shift, obtaining a sixth CQM value, CQM6, associated with the sixth phase shift.

In some embodiments, CQM1>CQM2, CQM4>CQM3, CQM4>CQM1, and selecting the reflector configuration comprises one of: selecting φ4 if CQM4>CQM5 and CQM4>CQM6; selecting φ5 if CQM5>CQM4 and CQM5>CQM6; or selecting φ6 if CQM6>CQM4 and CQM6>CQM5.

In some embodiments, the first reflector configuration specifies an off state, configuring the first particular configurable reflector in accordance with the first reflector configuration comprises placing the first particular configurable reflector in the off state, the second reflector configuration specifies an on state, and configuring the first particular configurable reflector in accordance with the second reflector configuration comprises placing the first particular configurable reflector in the on state.

In some embodiments, the method is performed by RIS 106, and the step of obtaining the CQM values comprises obtaining the CQM values from a network node (e.g., from UE 102 or AP 104 or server 190).

In some embodiments, the method is performed by a network node (e.g., UE 102 or AP 104 or sever 190), and the step of configuring the first particular configurable reflector comprises transmitting a control message for the RIS, wherein the control message indicates the reflector configuration.

In some embodiments, the network node is UE 102, and the step of transmitting the control message for the RIS comprises: i) the UE transmitting the control message to the RIS or ii) the UE transmitting the control message to another network node capable of communicating with the RIS.

In some embodiments, the network node is an AP 104, and the step of transmitting the control message for the RIS comprises: i) the AP 104 transmitting the control message directly to the RIS or ii) AP 104 transmitting the control message to another network node (e.g., UE 102) capable of communicating with the RIS.

In some embodiments, the network node is server 190, and the step of transmitting the control message for the RIS comprises: i) the server transmitting the control message directly to the RIS or ii) the server transmitting the control message to another network node capable of communicating with the RIS.

In some embodiments, obtaining the first set of CQM values further comprises: configuring the first particular configurable reflector in accordance with a third reflector configuration; and after configuring the first particular configurable reflector in accordance with the third reflector configuration, obtaining a third CQM value associated with the third reflector configuration. In some embodiments, the third reflector configuration specifies a phase shift; and configuring the first particular configurable reflector in accordance with the third reflector configuration comprises configuring the first particular configurable reflector to produce the phase shift.

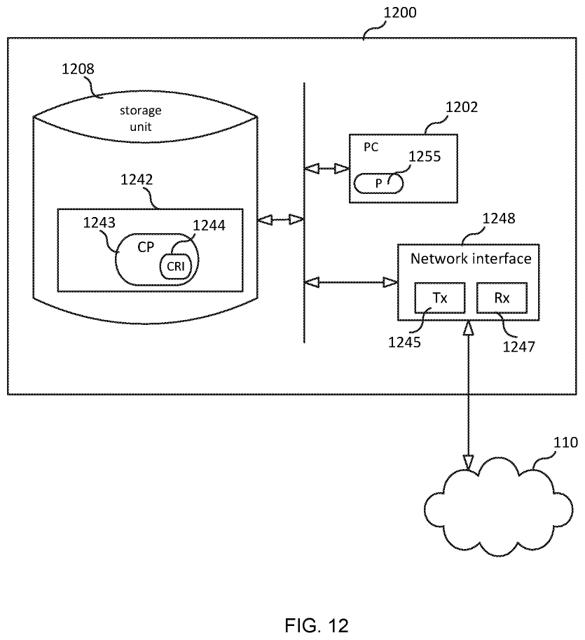

FIG. 12 is a block diagram of network node 1200, according to some embodiments, that can implement any one or more of the network nodes described herein. That is, network node 1200 can perform the above described methods. As shown in FIG. 12, network node 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., network node 1200 may be a distributed computing apparatus); at least one network interface 1248 comprising a transmitter (Tx) 1245 and a receiver (Rx) 1247 for enabling network node 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a storage unit (a.k.a., “data storage system”) 1208, which may include one or more non-volatile storage devices and/or one or more volatile storage devices. In embodiments where PC 1202 includes a programmable processor, a computer readable medium (CRM) 1242 may be provided. CRM 1242 stores a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes network node 1200 to perform steps described herein (e.g., steps described herein with reference to the flow charts). In other embodiments, network node 1200 may be configured to perform steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] M. Di Renzo, A. Zappone, M. Debbah, M.-S. Alouini, C. Yuen, J. de Rosny, and S. Tretyakov, “Smart Radio Environments Empowered by Reconfigurable Intelligent Surfaces: How It Works, State of Research, and The Road Ahead,” IEEE J. Sel. Areas Commun., vol. 38, no. 11, pp. 2450-2525, 2020.
[2] Q. Wu and R. Zhang, “Beamforming Optimization for Wireless Network Aided by Intelligent Reflecting Surface with Discrete Phase Shifts,” IEEE Trans. Commun., vol. 68, no. 3, pp. 1838-1858, 2020.
[3] V. Arun and H. Balakrishnan, “RFocus: Practical Beamforming for Small Devices”, USENIX 2019.

1. A method for configuring a reconfigurable intelligent surface, RIS, wherein the RIS comprises a plurality of configurable reflectors, the method comprising:
obtaining a first set of channel quality measurement, CQM, values, wherein the first set of COM values is associated with at least a first particular configurable reflector of the RIS, and further wherein each CQM value included in the set is associated with a reflector configuration;
based on the obtained first set of CQM values, selecting a reflector configuration; and
configuring at least the first particular configurable reflector based on the selected reflector configuration, wherein
a) the method is performed by the RIS and the step of obtaining the CQM values comprises obtaining the CQM values from a network node, or
b) the method is performed by a network node and the step of configuring the first particular configurable reflector comprises transmitting a control message for the RIS, wherein the control message indicates the reflector configuration.

2. The method of claim 1, wherein obtaining the first set of CQM values comprises:
configuring the first particular configurable reflector in accordance with a first reflector configuration;
after configuring the first particular configurable reflector in accordance with the first reflector configuration, obtaining a first CQM value, CQM1, associated with the first reflector configuration;
configuring the first particular configurable reflector in accordance with a second reflector configuration; and
after configuring the first particular configurable reflector in accordance with the second reflector configuration, obtaining a second CQM value, CQM2, associated with the second reflector configuration.

3. The method of claim 2, wherein selecting a reflector configuration based on the obtained first set of CQM values comprises:
determining the best CQM value from among the CQM values included in the first set of CQM values; and
selecting the reflector configuration associated with the best CQM value.

4. The method of claim 2, wherein selecting a reflector configuration based on the obtained first set of CQM values comprises:
comparing the first CQM value with the second COM value; and
selecting the first or second reflector configuration based on the comparison.

5. The method of claim 4, wherein selecting the first or second reflector configuration based on the comparison comprises:
selecting the first reflector configuration if the first CQM value is greater than the second CQM value;
selecting the second reflector configuration if the first CQM value is less than the second CQM value; or
selecting either the first or the second reflector configuration if the first CQM value is equal to the second CQM value.

6. The method of claim 2, wherein
the first reflector configuration specifies a first phase shift,
configuring the first particular configurable reflector in accordance with the first reflector configuration comprises configuring the first particular configurable reflector to produce the first phase shift,
the second reflector configuration specifies a second phase shift, and
configuring the first particular configurable reflector in accordance with the second reflector configuration comprises configuring the first particular configurable reflector to produce the second phase shift.

7. The method of claim 6, wherein
the first phase shift, φ1, is X radians, and
the second phase shift, φ2, is (X+π) or (X−π) radians.

8. The method of claim 2, wherein
the first reflector configuration specifies an off state,
configuring the first particular configurable reflector in accordance with the first reflector configuration comprises placing the first particular configurable reflector in the off state,
the second reflector configuration specifies an on state, and
configuring the first particular configurable reflector in accordance with the second reflector configuration comprises placing the first particular configurable reflector in the on state.

9. The method of claim 1, wherein
the method is performed by the RIS, and
the step of obtaining the CQM values comprises obtaining the CQM values from a network node.

10. The method of claim 9, wherein the network node is:
a user equipment,
an access point, or
a server.

11. The method of claim 1, wherein
the method is performed by a network node, and
the step of configuring the first particular configurable reflector comprises transmitting a control message for the RIS, wherein the control message indicates the reflector configuration.

12. The method of claim 11, wherein
the network node is a user equipment, UE, and
the step of transmitting the control message for the RIS comprises: i) the UE transmitting the control message to the RIS or ii) the UE transmitting the control message to another network node capable of communicating with the RIS.

13. The method of claim 11, wherein
the network node is an access point, AP, and
the step of transmitting the control message for the RIS comprises: i) the AP transmitting the control message directly to the RIS or ii) the AP transmitting the control message to another network node capable of communicating with the RIS.

14. The method of claim 11, wherein
the network node is a cloud server, and
the step of transmitting the control message for the RIS comprises: i) the cloud server transmitting the control message directly to the RIS or ii) the cloud server transmitting the control message to another network node capable of communicating with the RIS.

15. The method of claim 8, wherein obtaining the first set of COM values further comprises:
configuring the first particular configurable reflector in accordance with a third reflector configuration; and
after configuring the first particular configurable reflector in accordance with the third reflector configuration, obtaining a third CQM value associated with the third reflector configuration.

16. The method of claim 15, wherein
the third reflector configuration specifies a phase shift; and
configuring the first particular configurable reflector in accordance with the third reflector configuration comprises configuring the first particular configurable reflector to produce the phase shift.

17. (canceled)

18. (canceled)

19. (canceled)

20. (canceled)

21. A non-transitory computer readable storage medium storing instructions which when executed by processing circuitry of a network node causes the network node to perform the method of claim 1.

22. (canceled)

23. A first network node for configuring a reconfigurable intelligent surface, RIS, wherein the RIS comprises a plurality of configurable reflectors, the first network node comprising:
a storage unit; and
processing circuitry coupled to the storage unit, wherein the network node is configured to:
obtain a first set of channel quality measurement, COM, values, wherein the first set of CQM values is associated with at least a first particular configurable reflector of the RIS, and further wherein each CQM value included in the set is associated with a reflector configuration;
based on the obtained first set of CQM values, select a reflector configuration; and
configure at least the first particular configurable reflector based on the selected reflector configuration, wherein
a) the first network node is the RIS and the step of obtaining the CQM values comprises obtaining the COM values from a second network node, or
b) the step of configuring the first particular configurable reflector comprises transmitting a control message for the RIS, wherein the control message indicates the reflector configuration.

24. (canceled)

25. (canceled)
